(19) United States
(12) Patent Application Publication
(10) Pub. No.: US 2010/0139508 A1
(43) Pub. Date: Jun. 10, 2010

(54) Garlic Press

(76) Inventors: Douglas Hansel, Lewis Center, OH (US); Christopher L. Hawker, Columbus, OH (US); Sommer Renaldo, Columbus, OH (US)

Correspondence Address: JOHN R. BENEFIEL, 525 Lewis Street, BIRMINGHAM, MI, 48009, US

(21) Appl. No.: 12/635,026

(22) Filed: Dec. 10, 2009

Related U.S. Application Data
(60) Provisional application No. 61/201,450, filed on Dec. 10, 2008.

(51) Int. Cl. B30B 7/00

(52) U.S. Cl. 100/234

(57) ABSTRACT

A hand operated garlic press includes a pair of crossed levers operated by pivoted together handles combined with the cross levers to easily create a strong crushing pressure in a pressure chamber into which garlic cloves are placed through an open front end of the chamber.

### CROSS REFERENCE TO RELATED APPLICATIONS

This application claims the benefit of U.S. provisional patent application No. 61/201,450 filed on Dec. 10, 2008.

### BACKGROUND OF THE INVENTION

This application concerns manually operated garlic presses which are used to crush garlic cloves to obtain finely divided fresh garlic for use in cooking.

Such presses have long been in use and typically are of a “nutcracker” design, wherein a pair of handles are hinged at one end and connected to a pressure plate located between the handles and forced down into a pressure chamber, also located between the handles. The pressure chamber is defined by a perforated bottom plate and surrounding side walls. The pressure plate is advanced down into the pressure chamber by squeezing the handles together which crushes the garlic inserted beneath the pressure plate and forces it through the bottom plate holes.

In conventional designs, significant effort is required to squeeze the handles with sufficient force so as to push the garlic through the bottom plate holes. If the pressure applied is insufficient some of the crushed garlic may not be forced through the holes and remains on the bottom plate and is then cleaned out with the garlic clove skin and wasted.

The pressure chamber being completely enclosed by the surrounding walls and located between the two operating handles is not easily accessed to load garlic cloves therein, and the recessed perforated bottom plate is also difficult to keep clean.

In U.S. Ser. No. 10/592,300 published as U.S. 2007/0175342A1, a hand-operated double lever garlic press is described, intended to reduce the effort required, but further reductions in effort using that design are desirable, and it would be advantageous to provide a more easily accessed pressure chamber in such a garlic press.

It is an object of the present invention to reduce the effort required to operate a hand operated garlic press so as to completely crush garlic cloves, as well as to make loading garlic cloves into the press pressure chamber easier than that of conventional garlic presses.

### SUMMARY OF THE INVENTION

The above object and other objects of the present invention which will be understood upon a reading of the following specification and claims are achieved by a handle operated garlic press having a pressure chamber which is open on front side which allows easier insertion of items to be crushed, and also allows a perforated bottom plate in the pressure chamber to be pivoted out and exposed for easier cleaning.

Access to the pressure chamber is also made easier by not being located between the handles, but instead by a geometry in which the handles do not extend across the pressure chamber as in many of the conventional garlic presses.

Rather, the pressure chamber is located forward of the handles and the pressure plate is moved against the bottom plate by an intermediate lever system extending from the handle rather than directly by the handles located over the pressure chamber.

Improved leverage is achieved by the handles being pivoted together at one end and located well behind the pressure chamber, and a pair of crossed levers which carry out the compression of the item are pivoted to each other at an intermediate point along their lengths, and each cross lever is also pivoted at one end to a respective handle at a point closer to the handle pivot ends than to the free end of the handles to create a mechanical advantage in being operated to crush an item in the pressure chamber.

The other end of one of the cross levers has the pressure chamber fixed thereto while the other end of the other cross lever has a plunger bar mounted to the pressure plate and pivoted thereto allowing the attached pressure plate to be swung back from a perforated bottom plate defining in part the pressure chamber. The pressure plate is guided downwardly in the pressure chamber by guide slots in the side walls of the pressure chamber receiving projections on the pressure plate instead of being guided by a front wall of the pressure chamber. This allows the pressure chamber to be open at the front allowing easy access thereto to insert garlic cloves beneath a retracted pressure plate to be crushed upon squeezing together the handles.

The bottom plate is pivoted along a front side to be able to be swung out once the pressure plate is swung up and back out of the way, for providing complete access to the bottom plate convenient cleaning thereof.

The pivotally connected handles provide a first stage lever system in carrying out a compressing stroke of the pressure plate by the shorter distance from their pivoted ends to the point of connection to the cross levers than from the pivoted ends to the handle free ends.

A second stage lever system having a mechanical advantage is provided by the shorter distance from the location of the pivot of the cross levers to the pivot connection of pressure plate plunger bar than the distance from the cross pivot to the pivot connection of each of cross the levers to a respective handle.

This creates a greater overall mechanical advantage in advancing the pressure plate by squeezing the handles than prior presses, and thus requires only a modest effort by the user to generate a powerful crushing force which can force all of the clove meat through the bottom plate openings.

The assembly of the crossed levers and pivoted together handles is compact by slots and recesses receiving the levers when the handles are closed together.

### DESCRIPTION OF THE DRAWINGS

FIG. 1 is an enlarged pictorial view from the front of a manually operated garlic press according to the present invention, with operating handles squeezed together and a pressure plate fully advanced against the bottom plate of a pressure chamber.

FIG. 2 is a pictorial view from the front of the garlic press shown in FIG. 1 with the handles fully opened and the pressure plate retracted in preparation for a press operation.

FIG. 3 is a pictorial view of the garlic press as shown in FIGS. 1 and 2 with the pressure plate pivoted back to allow swinging out the perforated bottom plate defining a pressure chamber.

FIG. 4 is a pictorial view from the front of the garlic press shown in FIGS. 1-3 with the perforated bottom plate flipped out for cleaning.

FIG. 5 is an exploded perspective view of the components of the garlic press shown in FIGS. 1-4.

FIG. 6 is a side view from of the garlic press shown in FIGS. 1-4 with the handles opened and the pressure plate in its pivoted back position, with dimension lines indicating the component lengths creating the mechanical advantage obtained by the cross lever pivot locations.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

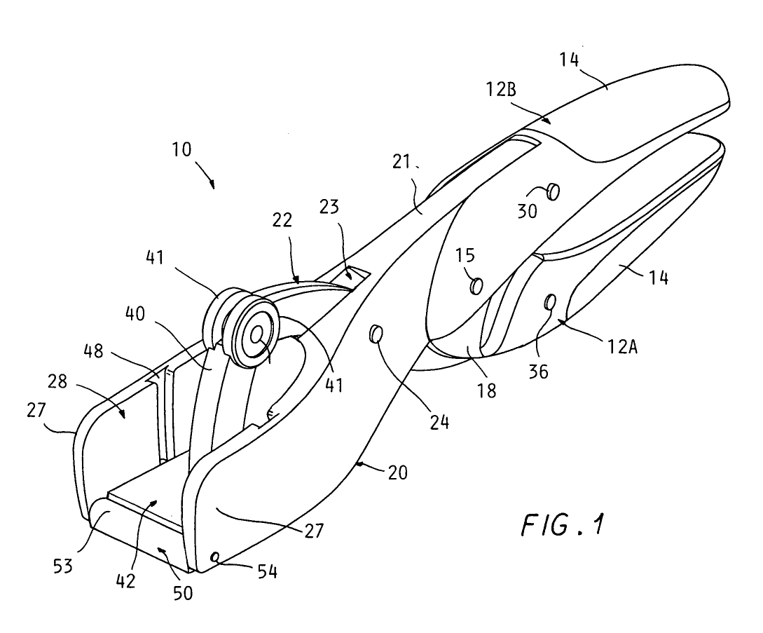

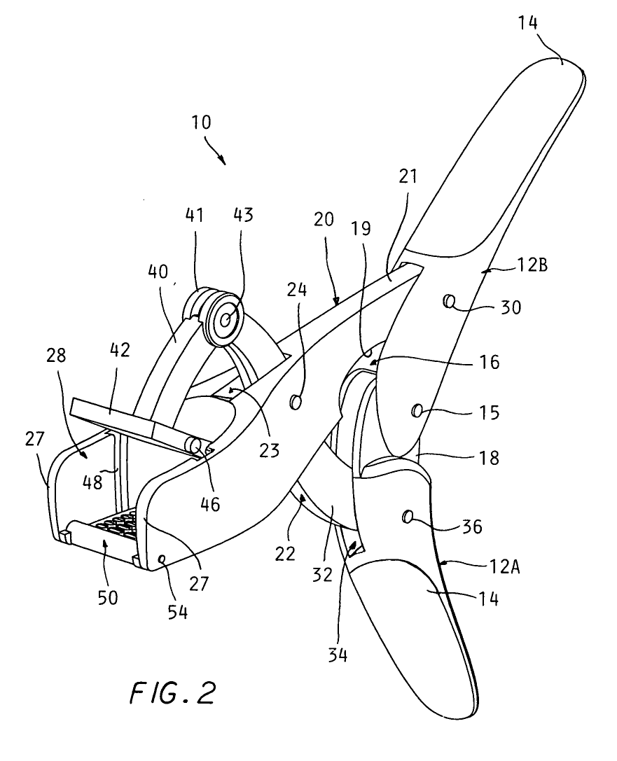

Referring to the drawings and particularly FIGS. 1 and 2, a garlic press 10 according to the present invention is shown which includes a pair of generally elongate handles 12A, 12B, which may be constructed of cast aluminum, steel, stainless steel or plastic or other material and provided with soft elastomeric pads 14.

The handles 12A, 12B have interfit portions at one end which are pivotally connected to each other by a pivot pin 15. Upper handle 12B is formed with a clevis opening 16 and handle 12A with a reduced thickness end 18 fit therein with sufficient clearances provided to allow the handles 12A, 12B to be spread apart as shown in FIG. 2.

The pivotally connected together handles 12A,12B define a first lever system which operates a second lever system defined by a pair of crossed levers 20, 22 which also may be constructed of stainless steel, cast aluminum, plastic, ect., pivotally connected together at a location intermediate their ends with a pivot pin 24.

Cross lever 22 passes through a slot 23 extending through the middle of cross lever 20 which is long enough to permit pivoting movement of cross lever 22 therein.

One of the cross levers 20 has a U-shaped space 26 between two separated curved end portions 27 at one end which together with a perforated bottom plate 50 define two sides and a bottom of a scoop shaped pressure chamber 28.

Cross lever 20 is formed with a narrower blade portion 21 at its other end which is received in the clevis opening 16 of the upper handle 12B and is pivotally mounted therein to the handle 12B with a pin 30.

The other cross lever 22 is shaped as a very shallow letter S and has one end 32 received in a recess 34 in the handle 12A so as to be swingable therein about a pivot defined by a pin 36.

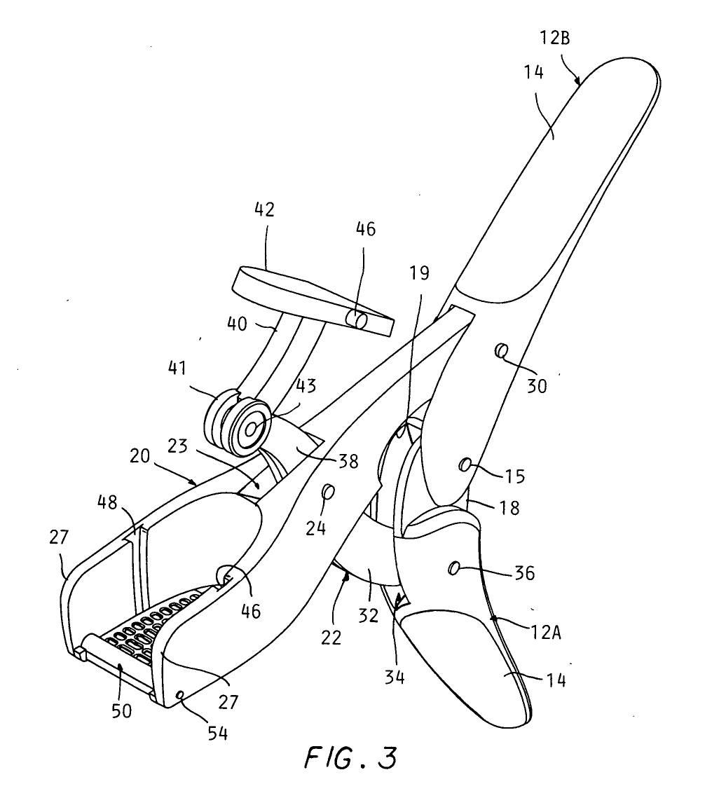

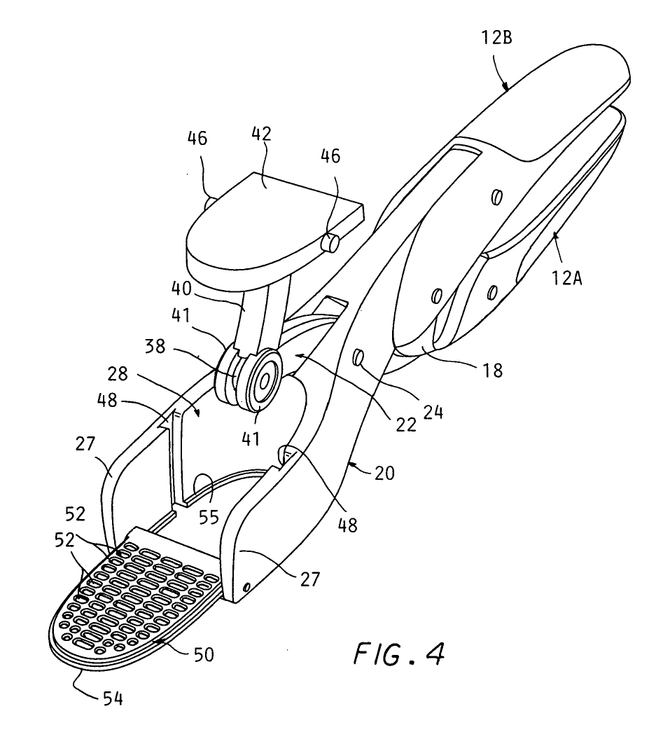

The other end 38 of the other cross lever 22 is rounded and of a reduced thickness with a hole 39 formed therein, which is received between gudgeons 41 integrally formed at an upper end of a plunger bar 40 which is integrally fixed to a pressure plate 42 at the other end. A pin 43 established a rotatable connection between cross lever end 38 and gudgeons 41. This allows the pressure plate 42 to be swung up out of the way as seen in FIGS. 3 and 4 or swung down to ready the garlic press 10 for operation as seen in FIG. 2.

When swung down, projections 46 on opposite sides of the pressure plate 42 enter guide slots 48 on the inner surface of each sides 27 with a rounded entry insuring that the projections 46 will enter the slots 48 when the lever ends are moved together. The interaction between the guide projections 46 and slots 48 controls the pivoting of the pressure plate 42 so as to be constrained to descend and be pivoted to eventually assume an orientation parallel to perforated bottom plate 50 of the pressure chamber 28 as the cross lever 22 end 38 is swung down by the user squeezing together the handles 12A and 12B.

The bottom plate 50 is preferably constructed of stainless steel and has an array of through elongated holes 51 and slots 52 formed therein. The use of slots 52 instead of all round holes maximizes the effective open area of the bottom plate 50, and is preferred over the use of holes only to create the openings.

The bottom plate 50 is rounded at one end to mate with the rounded shape of the inner end of the pressure chamber 28 and is pivotally mounted at its other end with a pin 54 received through a hole in an end bar 53 and in a hole 57 in both of the pressure chamber side walls 27.

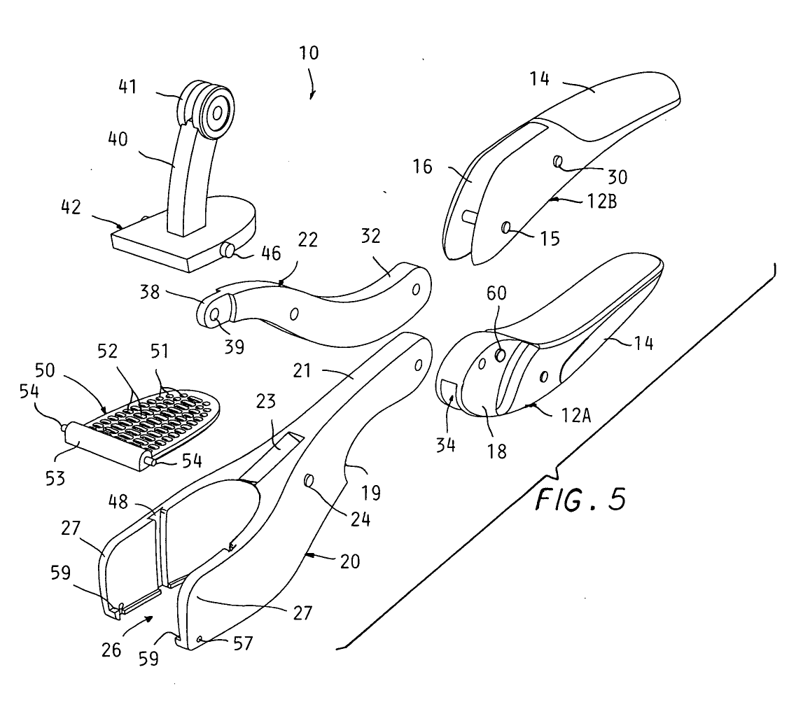

The bottom plate 50 has a stepped perimeter edge 54 which rests on a shoulder 55 extending around the bottom of the U-shaped opening 26 to be positively secured in position closing off the bottom of the cavity 26 in an operative position shown in FIG. 5.

A stop 59 (FIGS. 2,5) can be formed on each side to hold the bottom plate 50 in a flipped out horizontal position shown in FIG. 4 for ease in cleaning. In addition, the pressure plate 42 when lowered as seen in FIG. 1 will lock the bottom plate 50 in its flipped out position to make scrubbing easier.

The bottom plate 50 can also be sized to have a slight press fit to the pressure chamber walls in the operative position so as to be releasably held in position by frictional contact.

Since the pressure plate 42 is not guided by the constraint of a front wall of the pressure chamber 28 but by the interaction of guide projections 46 and slots 48, this allows the front of the chamber 28, to be open as shown, allowing free access thereto for placing cloves of garlic in the pressure chamber 28 from the front. The pressure plate 42 is tilted up at its front side as seen in FIG. 2, at the beginning of a stroke so that garlic cloves or other items to be crushed can be conveniently inserted in the space below the pressure plate 42.

As noted above, the bottom plate 50 can be swung up and out through the open front end of the chamber 28 for cleaning as seen in FIG. 4.

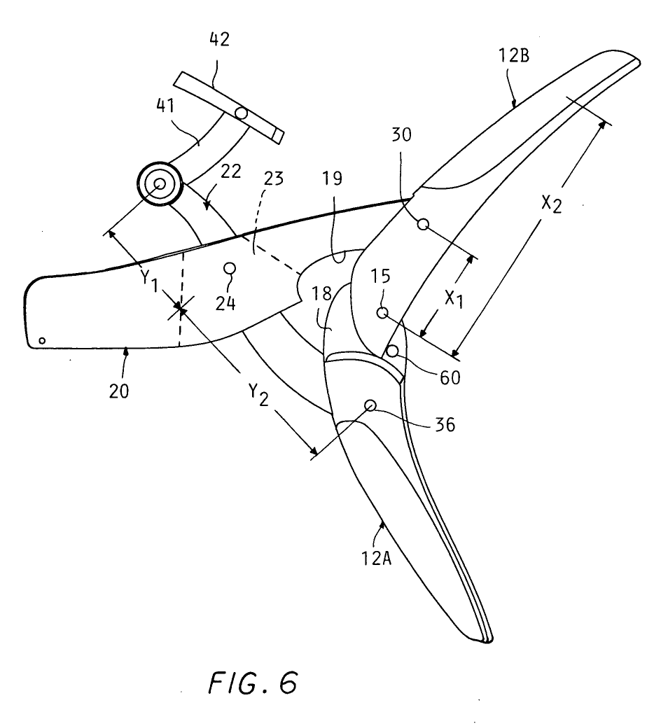

Referring to FIG. 6, the mechanical advantage exerted by the handles 12A, 12B approximates the ratio of the shorter distances X₁, from pivot 15 to pivot 36, and the longer distances X₂ from pivot pin 15 to approximately the end of the handles 12A, 12B. The distances X₂ would vary somewhat depending on where the user's hand was located but would normally be longer than the distance X₁.

This leverage is then exerted on the second lever system via pins 36, which develops a mechanical advantage equal to the shorter distance Y₁, from the pivot pin 24 to the pivot 38 divided into the longer distance Y₂ from the pivot 24 to the pivot 36.

Thus, a compounded mechanical advantage is obtained by this combination of two lever systems.

A pair of spring loaded detent balls or pins 60 can be provided on opposite sides of the end 18 of handles 12A to limit opening of the handles 12A, 12B to that position shown in FIGS. 2 and 6 to locate the handles 12A,12B in the desired position to be ready for a squeeze stroke.

As can also be seen in FIG. 6, the recess 23 angles forwardly to accommodate the pivoting movement of cross lever 22. The underside of the cross lever 20 is scalloped at 19 to accommodate the end 18 of the lower handle 12A as the handles 12A,12B are squeezed together.

Accordingly, relatively great pressure can be developed without the need for an excessive exertion by the user such that a maximum amount of the meat of the garlic clove or cloves is forced though the holes 51 and slots 52.

The open front of the chamber 28 facilitates loading, while the swing out bottom plate 50 allows convenient access for cleaning.

The interfitting of the cross levers 20, 22 and handles 12A, 12B within the various slots and recesses described creates a compact assembly in the closed position.

1. A manually operated press comprising:
a first handle having a first end and a second opposing end;
a second handle having a first end and a second opposing end;
a first lever having a first end and a second opposing end; and
a second lever having a first end and second opposing end;
wherein the second end of the first handle and the second end of the second handle are pivotally attached to one another at a first pivot;
the second end of the first lever has attached a pressure chamber for receiving material to be crushed, the first end of the first lever arm pivotally attached to the first handle at a point intermediate the length of the first handle to form a second pivot, the second end of the second lever arm has mounted thereto a pressure plate adopted to be advanced into said chamber upon pivoting of said second lever, and the first end of the second lever pivotally attached to the second handle at a point intermediate the length of the second handle to form a third pivot, and wherein the first and second lever arms cross each other at a point intermediate their length and the first and second lever arms are pivotally attached to one another at said intermediate point where the lever arms cross each other; and
wherein distances from said intermediate point to said second and third pivots is longer than distances to said pressure plate and pressure mountings to thereby generate a mechanical advantage exerted to advance said pressure plate in said chamber by squeezing said handles together.

2. The hand press according to claim 1 wherein distances from second and third pivots to said first pivots are substantially shorter than one half the length of said handlers to create a mechanical advantage exerted on said first and second cross levers by squeezing said handles together.

3. A hand press for crushing items, said press including:
a pair of cross levers pivoted together at a location where said levels cross each other;
a scoop shaped pressure chamber on one end of one cross lever;
a pressure plate mounted on an adjacent one end of the other cross lever which is brought down into said pressure chamber when said one ends of said crossed levers are brought together by operation of said hand press, said pressure chamber having three sides and a bottom plate located below said pressure plate and being open at the front to enable loading of items onto said bottom plate from the front end of said hand press.

4. The hand press according to claim 3 wherein said bottom plate is formed with a series of openings enabling crushed material from said item to be forced through said bottom plate openings upon descent of said pressure plate.

5. The hand press according to claim 3 wherein a pair of pivoted together handles are connected to said cross levers at ends thereof opposite said pressure plate and chambers, each handle pivoted to a respective cross lever.

6. The hand press according to claim 4 wherein said bottom plate is hinged along an outer side at the front of said chamber to allow said bottom plate to be swung out from said pressure chamber to be more accessible for cleaning.

7. The hand press according to claim 6 wherein said pressure chamber has a shoulder formed along the bottom perimeter thereof upon which said bottom plate perimeter rests when positioned within said pressure chamber.

8. The hand press according to claim 6 wherein said pressure plate is pivotally mounted to said other lever and enabled to be pivoted back to provide clearance for said bottom plate being swung out of said pressure chamber.

9. The hand press according to claim 8 wherein said pressure plate has a guide projection on either side thereof and wherein a slot is formed into the inside of each of two opposite sides of said pressure chamber located to receive a respective one of said pressure plate guide projections and said projections advancing down said slots when said cross lever ends are brought together in operating said press to cause said pressure plate to assume an orientation level with the bottom of said pressure chamber upon continued downward advance of said bottom plate in said pressure chamber.

10. The hand press according to claim 9 wherein a distance from said crossing point to said mounting of said pressure plate is substantially shorter than the distance from said crossing point to the end of said one lever pivoted to one handle to create a mechanical advantage in advancing said pressure plate.

11. The hand press according to claim 3 wherein said one cross lever has a pair of spaced apart walls forming two opposite sides of said pressure chamber.

12. The hand press according to claim 11 wherein a through slot is formed into said one cross lever at said crossing point receiving the other of said cross levers extending through said slot and swingable thereon to allow said one ends to be moved together by pivoting at said crossing point.

13. The hand press according to claim 12 wherein a flattened opposite end of said one cross lever extends into a slot in one of said handles to which it is pivotally attached.

14. The hand press according to claim 13 wherein said other end of said other cross lever is received into a recess in a handle to which it is pivotally attached.

15. The hand press according to claim 10 wherein shoulders are formed to locate said bottom plate extending directly out from said pressure chamber when swung out therefrom.

16. The hand press according to claim 12 wherein said pressure plate is inclined with an outer side up prior to carrying out a crushing stroke to provide an opening for receiving items to be crushed inserted therein.

17. The hand press according to claim 4 wherein said openings include an array of slots found in said bottom plate.
